(19) United States
(12) Patent Application Publication
(10) Pub. No.: US 2010/0294806 A1
(43) Pub. Date: Nov. 25, 2010

(54) Door Handle and Antibacterial Dispenser

(76) Inventor: Thomas McDowell, Inman, SC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/732,501

(22) Filed: Mar. 26, 2010

Related U.S. Application Data
(60) Provisional application No. 61/164,070, filed on Mar. 27, 2009.

(51) Int. Cl. B67D 7/84

(52) U.S. Cl. 222/173

(57) ABSTRACT

A door-handle apparatus includes a handle assembly that can be used to move a door. A reservoir for holding a sanitizing agent may be positioned within a cavity defined by the handle assembly. A sanitizing agent dispenser is coupled to the handle assembly and is in communication with the reservoir. The sanitizing agent dispenser may be positioned so that it releases the sanitizing agent in a direction away from the handle assembly. The reservoir may be removable from the handle assembly. An opening in the handle assembly may provide access to the reservoir. The handle assembly may be attached to a support plate that is secured to a door.

### CROSS REFERENCE TO RELATED APPLICATIONS

This application claims priority to and incorporates entirely by reference co-pending U.S. Provisional patent application Ser. No. 61/164,070 filed on Mar. 27, 2009.

### FIELD OF THE INVENTION

The present invention embraces a novel door-handle apparatus that includes a sanitizing agent dispenser for releasing a sanitizing agent.

### BACKGROUND OF THE INVENTION

Many surfaces that humans come into contact with are contaminated with bacteria and other germs that cause diseases. For example, such germs are commonly found on door handles. It is well understood that keeping one's hands sanitized, particular after contact with a contaminated surface, is important to prevent the spread of diseases.

Various devices have been developed to promote hand sanitation. For example, United States Patent Application Publication No. 2008/0305020 (Oshmyansky) discloses an assembly used to move a door that is coupled to a sanitizing agent dispenser. The sanitizing agent dispenser is coupled to an exterior reservoir containing a sanitizing agent. The sanitizing agent dispenser releases the sanitizing agent onto the hands of the user whenever the assembly is manipulated to open or close a door.

One problem with such an approach is that a portion of the sanitizing agent tends to remain on the assembly, which over repeated uses of the assembly can result in an unpleasant buildup of sanitizing agent. Moreover, a user may wish to avoid contact with the sanitizing agent entirely (e.g., if the user has just washed his hands). Accordingly, a need for a door-handle assembly that prevents the buildup of sanitizing agent and that gives users the option of applying or not applying a sanitizing agent on their hands. Furthermore it is desirable to have a compact door-handle assembly (e.g., a door-handle assembly that does not require an external reservoir containing a sanitizing agent).

### SUMMARY OF THE INVENTION

In one aspect, the present invention embraces a door-handle apparatus that includes a handle assembly used to move a door. The handle assembly may define a cavity. A reservoir for holding a sanitizing agent may be at least partially contained within the cavity. The door-handle apparatus may also include a sanitizing agent dispenser that is coupled to the handle assembly. The sanitizing agent dispenser is in communication with the reservoir. The sanitizing agent dispenser is positioned to release the sanitizing agent in a direction away from the handle assembly.

### BRIEF DESCRIPTION OF THE DRAWINGS

FIG. 1 schematically depicts an axonometric view of a door-handle apparatus according to the present invention.

FIG. 2 schematically depicts an axonometric view of a door-handle apparatus according to the present invention with the reservoir removed from the door-handle apparatus.

FIG. 3 schematically depicts a sanitizing agent dispenser according to the present invention in use.

FIG. 4 schematically depicts an axonometric view of an alternative embodiment of a door-handle apparatus according to the present invention.

FIG. 5 schematically depicts an alternative embodiment of a door handle apparatus according to the present invention with the reservoir cap removed.

### DETAILED DESCRIPTION

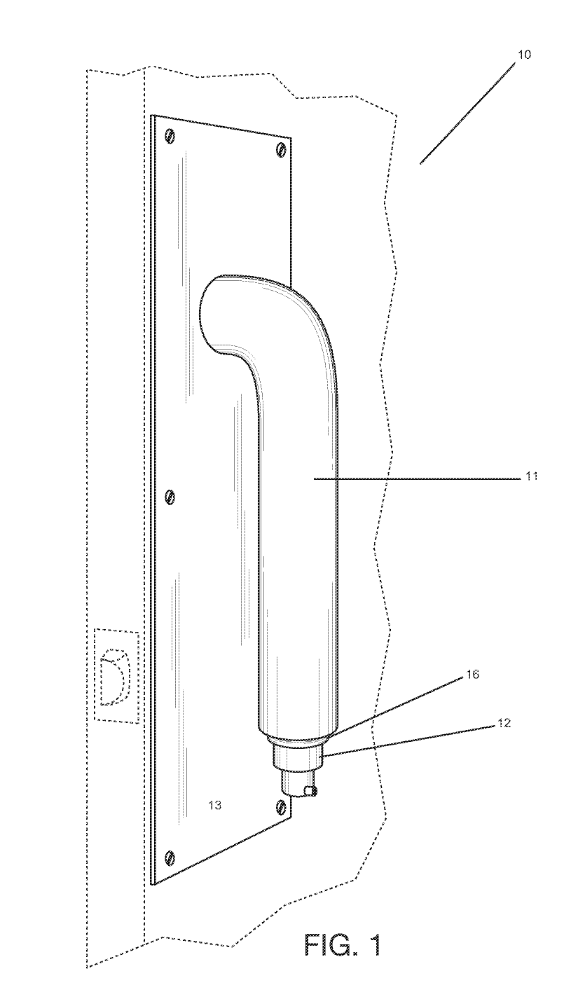

FIG. 1 depicts a door-handle apparatus 10 according to one embodiment of the present invention. The door-handle apparatus 10 includes a handle assembly 11. FIG. 1 depicts the handle assembly 11 as having a curved portion and an elongated cylindrical portion; however, any other suitable shape for the handle assembly 11 is within the scope of the present invention. For example, an optional stabilizing attachment, or brace, may also connect the bottom of the door handle to the door for a more secure fit.

The handle assembly 11 defines a cavity so that a reservoir for holding a sanitizing agent 17 may be at least partially contained within the cavity. The sanitizing agent may be, for example, any suitable antiseptic liquid or gel.

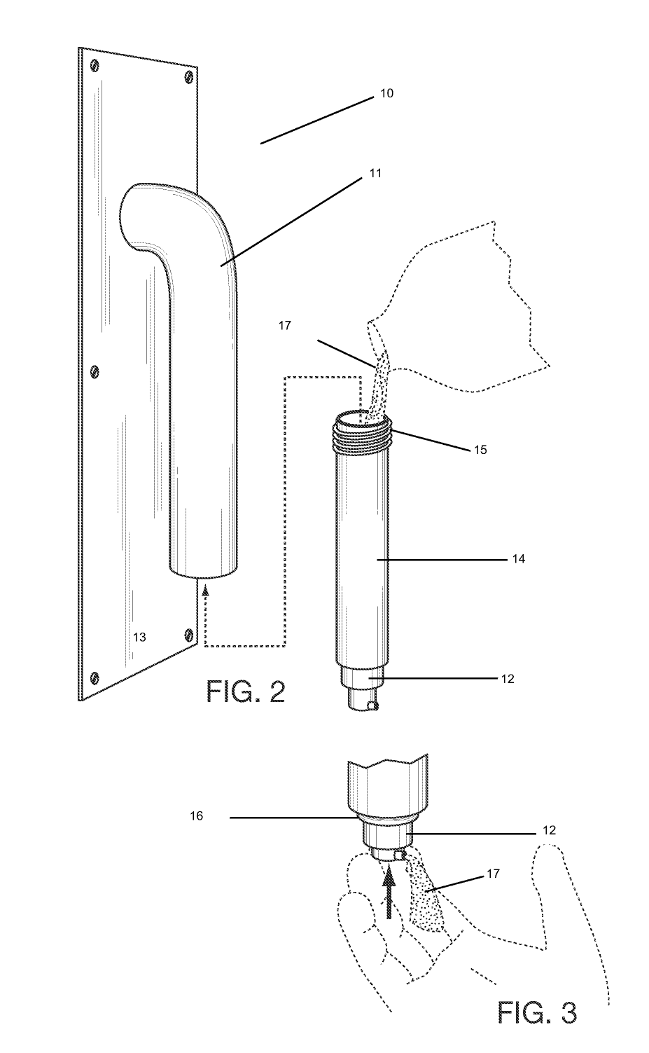

By way of example, FIG. 2 depicts a removable reservoir 14 for holding the sanitizing agent 17. Also as depicted in FIG. 2, the removable reservoir 14 may be refillable (e.g., after the removable reservoir is removed from the handle assembly 11). In one embodiment, the removable reservoir 14 may be disposable (i.e., the removable reservoir 14 may be designed to be disposed rather than refilled).

The removable reservoir 14 may be removably secured to the handle assembly 11 with threads 15 that are used to screw the removable reservoir 14 into the handle assembly 11, which may have threads that correspond to the threads 15 on the removable reservoir 14. The removable reservoir 14 may alternatively be removably secured to the handle assembly 11 with a polymeric washer 16 (e.g., a rubber washer) for holding the removable reservoir 14 in the cavity (e.g., with friction). Any other way of coupling the removable reservoir to the handle assembly 11 is within the scope of the present invention provided that it does not interfere with the operation of the door-handle apparatus 10.

In an alternative embodiment the reservoir 14 may not be removable (i.e., the reservoir 14 is fixedly secured to the handle assembly 11).

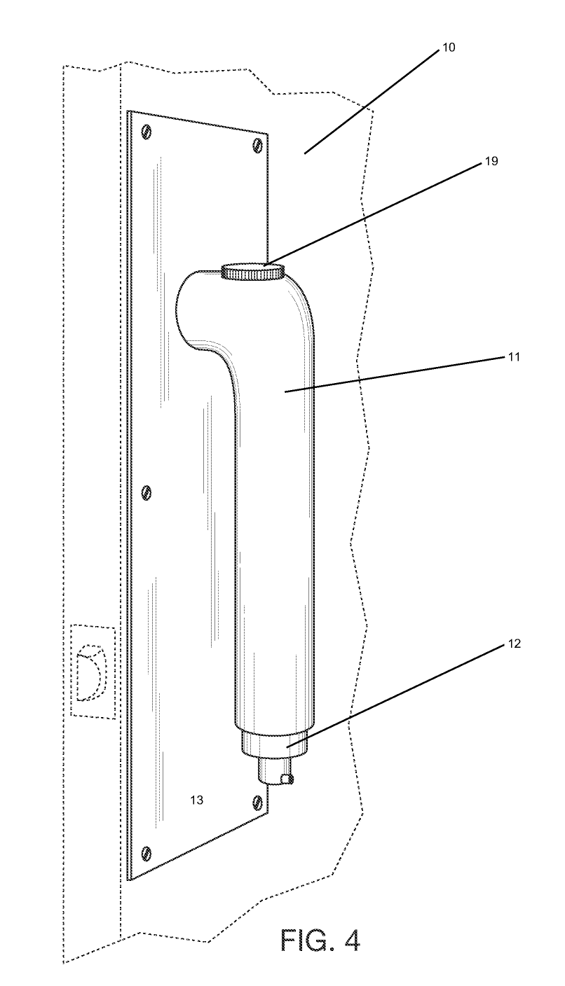

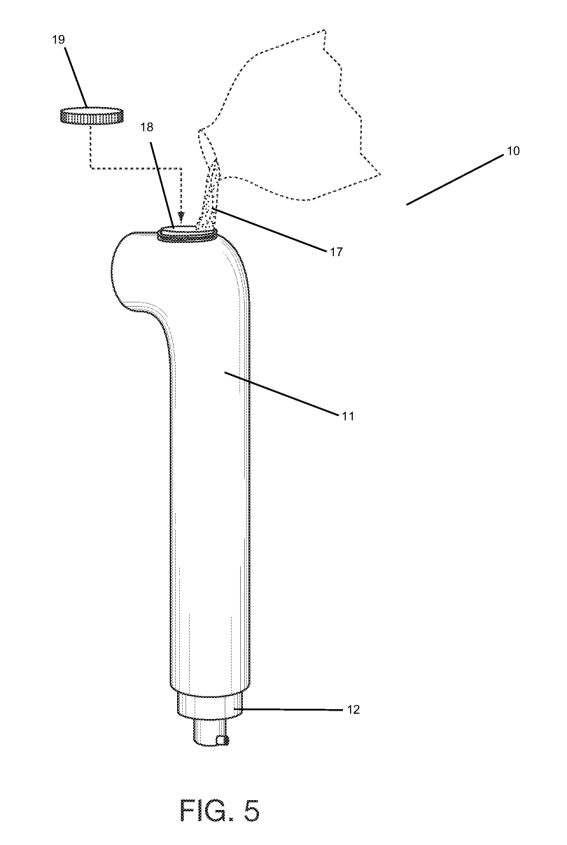

FIGS. 4 and 5 depict another embodiment of the present invention where the reservoir 14, which may or may not be removable, may be refillable through an opening 18 in the handle assembly 11, which is in communication with the reservoir 14. A cap 19 may be removably secured to the opening 18. The cap 19 may be removed so that the reservoir 14 may be refilled.

A sanitizing agent dispenser 12 may be coupled to the handle assembly 11. In one embodiment and as depicted in FIG. 2, the sanitizing agent dispenser 12 is directly connected to the reservoir 14 (i.e., the sanitizing agent dispenser 12 is removed from the handle assembly 11 when the reservoir 14 is removed). Alternatively, the sanitizing agent dispenser 12 may be fixed to the handle assembly 11. For example, the sanitizing agent dispenser may be coupled to the handle assembly so that the sanitizing agent dispenser 12 remains coupled to the handle assembly 11 if the removable reservoir 14 is removed from the handle assembly 11.

The sanitizing agent dispenser 12 may be in communication with the removable reservoir 14, so that the sanitizing agent dispenser 12 releases a sanitizing agent 17 held in the removable reservoir 14 when engaged by a user. For example and as depicted in FIG. 3, the sanitizing agent dispenser 12 may be a pump that is depressed by a user in order to release a sanitizing agent. Also as depicted in FIG. 3, the sanitizing agent dispenser 12 may be positioned so that it releases the sanitizing agent in a direction away from (i.e., downward from) the handle assembly 11.

The handle assembly 11 may be attached to a support plate 13. The support plate may be attached to a door that is opened with the door-handle apparatus 10. In an alternative embodiment, the handle assembly may be directly attached to a door (i.e., without the support plate 13).

One goal of the invention is to provide a door-handle apparatus that gives users the option of using a sanitizing agent. By positioning the sanitizing agent dispenser so that it releases the sanitizing agent away from the handle assembly, the buildup of the sanitizing agent on the handle can be avoided.

In one embodiment, the door handle sanitizer dispenser of this invention is significantly characterized by the dispenser portion, or pump, extending out of the bottom of the device. In this embodiment, a user can grip the body of the door handle along its long axis and entirely avoid the sanitizer dispensing mechanism. In a different use, the person can grip the bottom of the handle so that the pump or dispenser is in the palm of their hand, allowing for a single motion to pull the door open and pump the sanitizer at the same time. The dispenser according to this invention is therefore a significant development over all prior art devices.

Specific terms have been used only in a generic and descriptive sense, and not for purposes of limitation. Unless otherwise noted, the inventor is not acting as a lexicographer, and terms herein are intended to have their ordinary meaning. The invention is not restricted to the slavish imitation of each and every detail set forth above. Obviously, devices may be provided which change, eliminate, or add certain specific details without departing from the scope of the invention. The scope of the invention is set forth in the following claims.

1. A door-handle apparatus comprising:
a handle assembly used to move a door, wherein said handle assembly defines a cavity;
a reservoir configured for holding a sanitizing agent, wherein said reservoir is at least partially contained within said cavity;
a sanitizing agent dispenser, coupled to said handle assembly and in communication with said reservoir, wherein said sanitizing agent dispenser is positioned to release the sanitizing agent in a direction away from said handle assembly.

2. A door-handle apparatus according to claim 1, wherein said reservoir is removably secured to said handle assembly.

3. A door-handle apparatus according to claim 1, wherein said reservoir is fixedly secured to said handle assembly.

4. A door-handle apparatus according to claim 1, wherein said sanitizing agent dispenser is removably secured to said handle assembly.

5. A door-handle apparatus according to claim 1, wherein said sanitizing agent dispenser is fixedly secured to said handle assembly.

6. A door-handle apparatus according to claim 1, wherein said handle assembly defines an opening in communication with said reservoir.

7. A door-handle apparatus according to claim 1, wherein said door-handle apparatus further comprises a support plate for securing said door-handle apparatus to a door, and wherein said handle assembly is attached to said support plate.
